(19) United States
(12) Patent Application Publication
(10) Pub. No.: US 2007/0220087 A1
(43) Pub. Date: Sep. 20, 2007

(54) System for the sharing of electronic peripheral equipments

(75) Inventors: Chi-Tung Chang, Taipei City (TW); Wen-Chih Chen, Taipei City (TW)

Correspondence Address: BIRCH STEWART KOLASCH & BIRCH, PO BOX 747, FALLS CHURCH, VA, 22040-0747, US

(73) Assignee: Alcor Micro, corp.

(21) Appl. No.: 11/408,961

(22) Filed: Apr. 24, 2006

(30) Foreign Application Priority Data
Mar. 17, 2006 (TW) 095204516

(51) Int. Cl. G06F 15/16

(52) U.S. Cl. 709/203

(57) ABSTRACT

A system for the sharing of electronic peripheral equipments, wherein the system allows various industry standard electronic devices to share at least one electronic peripheral equipment. The aforesaid system comprises: a main server and a peripherals sharing interface that is installed in the main server, wherein the peripherals sharing interface has at least one signal input port and one signal output port, and the signal input port comprises at least a video input port, a mouse port and a keyboard port.

### TECHNICAL FIELD

This invention relates to a system for the sharing of electronic peripheral equipments, particularly a system for the sharing of electronic peripheral equipments that allows for the sharing of the display device, keyboard and mouse, and wherein the peripherals sharing interface has at least one signal input port and one signal output port, and the signal input port comprises at least a video input port, a mouse port and a keyboard port.

### BACKGROUND OF THE INVENTION

A conventional. Currently, a peripherals sharing interface that allows usage by various users is a type of signal switch, which is used to allow various users to use at least a keyboard, a display device and a mouse. The current peripherals sharing interface that are used comprise mainly external-connection systems, and their applications have generated the following problems: a huge packing space is used up, an additional external source of power is required, and when several electronic peripheral equipments are used at the same time, the cables can become entangled and bring about the risk of a person tripping over them.

The current application requirement is a system for the sharing of electronic peripheral equipments, comprising a main server and a peripherals sharing interface that is installed internally within the main server, which enables all main servers that are connected to the aforesaid system to use any of the peripheral equipments, and the peripherals sharing interface and the main server share the same power source and thus the packing space is reduced.

### SUMMARY OF INVENTION

The present invention relates to a system for the sharing of electronic peripheral equipments, comprising a main server and a peripherals sharing interface that is installed internally within the main server, which enables all main servers that are connected to the aforesaid system to use any of the peripheral equipments, and the peripherals sharing interface and the main server share the same power source and thus the packing space is reduced.

The system for the sharing of electronic peripheral equipments in the present invention allows several keyboards and mouses to communicate with a single computer platform at the same time, and a plurality of periphery channels are provided to the users, wherein the aforesaid channels can connect with all types of peripheral equipments, such as a printer, a scanner and a digital camera.

The system for the sharing of electronic peripheral equipments in the present invention comprises a main server and a peripherals sharing interface that is installed in the main server, wherein the peripherals sharing interface has at least one signal input port and one signal output port, and the signal input port comprises at least a video input port, a mouse port and a keyboard port.

### BRIEF DESCRIPTION OF DRAWINGS

FIG. 1 is the schematic diagram of the system for the sharing of electronic peripheral equipments in the present invention.

FIG. 2 is the relatively preferred embodiment for the system for the sharing of electronic peripheral equipments in the present invention.

### DETAILED DESCRIPTION OF PREFERRED EMBODIMENTS

In order to familiarize the relevant technical personnel with the objectives, characteristics and performance of the present invention, an explanation of the present invention is made with the following working examples in conjunction with the attached diagrams.

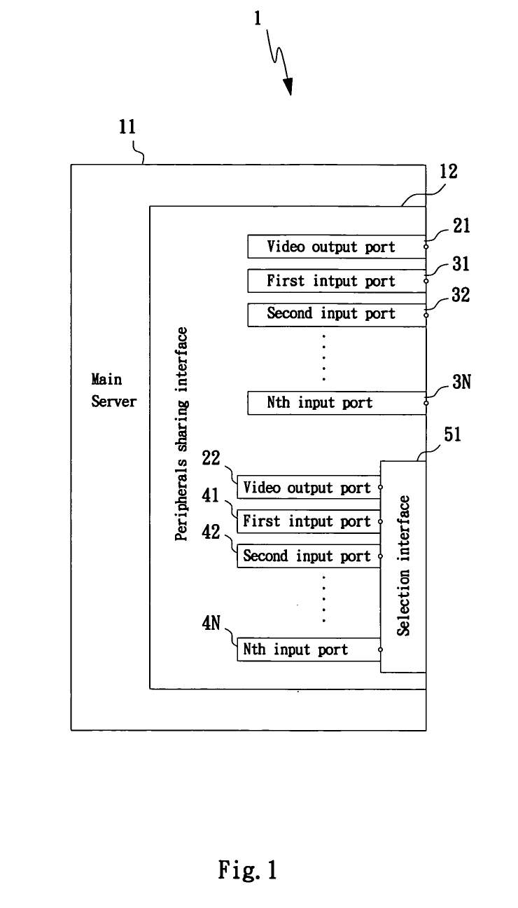

FIG. 1 is the schematic diagram of the system for the sharing of electronic peripheral equipments 1 in the present invention. The present embodiment comprises: a main server 11, a peripherals sharing interface 12 that is installed inside the main server 11, a video output port 21 for the output of video signals, a plurality of input ports from the first input port 31 to the nth input port 3N, a plurality of output ports from the first output port 41 to the nth output port 4N, and a selection interface 51 to select the corresponding input and output port for the various input and output signals from the system for the sharing of electronic peripheral equipments 1.

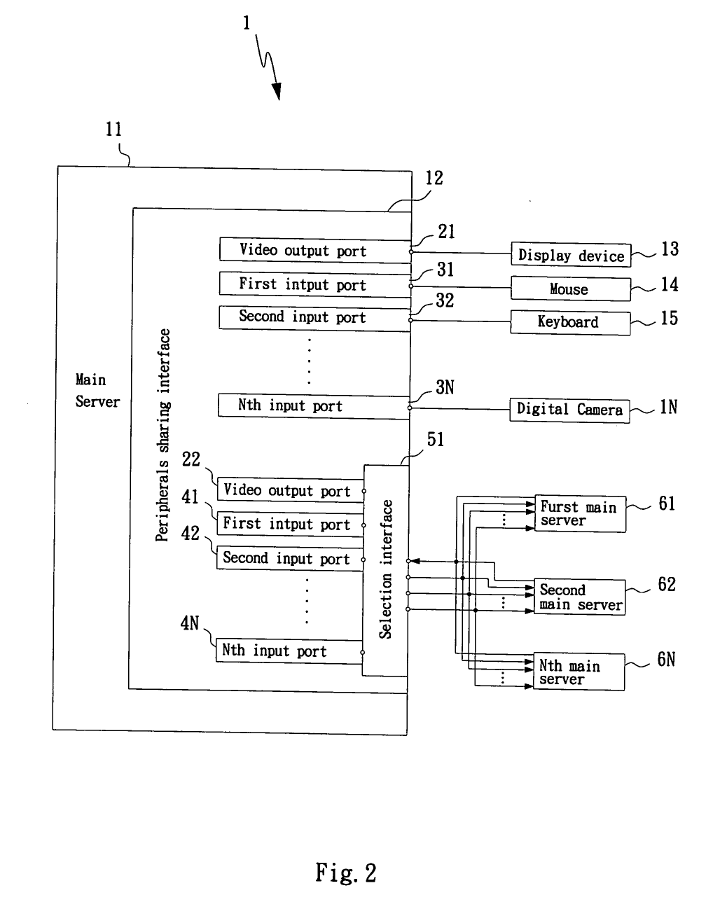

FIG. 2 is the relatively preferred embodiment for the system for the sharing of electronic peripheral equipments 1 in the present invention.

Various groups of video signals are input from different main servers 61 to 6N (e.g., computer) to the peripherals sharing interface 12 (e.g. interface card) that is installed in a main server 11 (e.g. computer). For example, the video input signals from the first main server 61 that are selected by the selection interface 51 can be input to the video input port 22, and then the video signals from the first main server 61 are output to a display device 13 (e.g. monitor screen), a mouse 14, a keyboard 15 and a digital camera IN through the video output port 21 that is installed in the peripherals sharing interface 12, and the signals are input to the main server 11 through the first input port 31, second input port 32 and nth input port. The input signals are then processed using the selection interface 51 on the peripherals sharing interface 12 in the main server 11, and three output ports are selected from the first output port 41 to the nth output port 4N for the selection interface 51 to selectively send out the mouse signals 14, keyboard signals 15 and digital camera signals IN to the first main server 61.

We claim:

1. A system for the sharing of electronic peripheral equipments, wherein the system allows various industry standard electronic devices to share at least one electronic peripheral equipment and wherein the aforesaid system comprises: a main server and a peripherals sharing interface that is installed in the main server, wherein the peripherals sharing interface has at least one signal input port and one signal output port, and the signal input port comprises at least a video input port, a mouse port and a keyboard port.

2. A system for the sharing of electronic peripheral equipments referred to in claim 1, wherein the peripheral equipments comprise at lease a display device, a keyboard and a mouse.

3. A system for the sharing of electronic peripheral equipments referred to in claim 1, wherein the industry standard refers to the device type definition of a humanity interface device.

4. A system for the sharing of electronic peripheral equipments referred to in claim 1, wherein the signal output port comprises at least one video output port.

5. A system for the sharing of electronic peripheral equipments referred to in claim 1, wherein the keyboard signals can be input through the keyboard input port, and the signals are 'selectively sent to various electronic equipments through some signal output ports, and wherein the mouse signals can be input through the keyboard input port, and the signals are selectively sent to various electronic equipments through some signal output ports.

6. A system for the sharing of electronic peripheral equipments referred to in claim 4, wherein video signals that are output from various electronic equipments can be selectively transmitted through some video output ports to at least one display device.
